(19) United States
(12) Patent Application Publication
(10) Pub. No.: US 2023/0130400 A1
(43) Pub. Date: Apr. 27, 2023

(54) THREE-STAGE RECURSIVE METHOD USING BEHAVIOR FINANCE ROBO-ADVISOR MODEL

(71) Applicant: Soochow University, Taipei City (TW)

(72) Inventor: Chung-Gee Lin, Taipei City (TW)

(21) Appl. No.: 17/556,018

(22) Filed: Dec. 20, 2021

(30) Foreign Application Priority Data
Oct. 22, 2021 (TW) 110139172

(51) Int. Cl. G06Q 40/06

(52) U.S. Cl. CPC G06Q 40/06

(57) ABSTRACT

An asset allocation method integrates the behavioral finance theory, optimization algorithm, and a 3 step algorithm. The method selects a plurality of assets upon a financial index by a computer system to create an asset group, then allocates the weight of the asset group to minimalize its standard deviation of expected profit and its skewness, and select another plurality of assets to refresh the asset group when its stability index exceeds a threshold value or has not refreshed for a stagnant duration. Thus, the asset allocation method would enable to provide the investor with a financial derivative and allocation model that met the investor's risk performance and earned a profit more than the benchmark.

### BACKGROUND OF THE INVENTION

### Field of the Invention

The present invention is classified as the field of asset management, particularly a method using a computer system to automatically select and allocate assets and reallocate assets according to market conditions.

### Description of the Prior Art

Wealth management which frequently plays a critical role to create business incomes in a financial institution is well known for its core business of developing an asset allocation model that makes profits robust for a client, enhances royalty of a client and appeals to a client depositing money in the financial institution. With fintech prospering recently, the competition model for business of financial management has been changed dramatically. For that matter, how to rely on technologies for cost reduction and improvement in performance of asset allocation has been a critical issue of each financial institution.

Accordingly, a variety of robo-advisors have been rolled out by the financial industry. However, most robo-advisors available in the market refer to traditional financial indexes and formalized investment strategies for investment behaviors but fail to instantly react with an important event affecting confidence of investors in a trading market. In case of a robo-advisor unadjusted artificially at this moment, the current performance of the robo-advisor is unsatisfactory or any opportunity to find another portfolio for better profitability is missed.

In virtue of above problems, how to provide a robo-advisor which reacts with an important event in a trading market to change an investment strategy and predict investor psychology is a critical issue nowadays.

### Summary of the Invention

A method using a computer system for asset allocation in the present disclosure is aimed at objects as follows:
1. Provide a robo-advisor conforming to the behavior finance theory;
2. Provide a robo-advisor with a rebalance mechanism inside;
3. Provide a robo-advisor with performance better than a current benchmark index of a market.

The method for asset allocation in the present disclosure relies on a computer system for execution of a three-stage recursive algorithm with steps as follows:

S1: A plurality of assets based on a finance index are selected from an asset trading market for creation of an asset group;
S2: A weight is allocated to an asset in the asset group for minimizing both the variance of an expected return of the asset group and the skewness coefficient;
S3: A stability index of the asset group is monitored constantly but another asset group is reconstructed in step S1 and a weight is reallocated to an asset in step S2 when maximum intraday drawdown or volatility of the existing asset group exceeds a default threshold or the existing asset group is not refreshed over a stagnant duration.

In step S1, the number of assets to be held is determined by an investor and assets with top financial indexes are selected by a computer system wherein the financial indexes can be an index of behavior finance, that is, the skewness coefficient, or the Alpha or Beta coefficient of the Capital Asset Pricing Model (CAPM).

In step S2, a weight is allocated for an asset group by a computer system according to the mean-variance optimization model of Dr. Markowitz, the Nobel Prize-winning economist, and research achievements of other scholars including Stilger, Amaya, Bali, DeMiguel and Murray, for example, an index of behavior finance, i.e., the skewness coefficient, is taken as the index in weight allocation for minimizing the standard deviation and the skewness coefficient.

In steps S3, a computer system checks the stability index to determine influence of volatility induced by a market event on an asset group. For that matter, the stability index refers to maximum intraday drawdown or volatility: maximum intraday drawdown is evaluated with data for Max Drawdown (MDD); volatility is evaluated with the Standard Deviation (SD) of an expected return of the asset group. MDD or the standard deviation for an asset group in the former period is chosen as a default threshold with which the stability of an existing asset group is evaluated.

Moreover, when the stability of an asset group worsened due to any market event is recognized and confirmed by the computer system, step S1 is resumed for reselection of other assets and followed by step S2 for weight reallocation and unsystematic risk diversification.

In addition, when an asset group is held by an investor over a stagnant duration during which no poor stability occurs, step S1 is resumed by the computer system to find another probable high-profit asset group for the investor holding the long-term high-stability asset group.

In summary, a method using a computer system for asset allocation is characteristic of evaluating an investor's behavior in a market through the skewness coefficient, coordinating with the mean-variance optimization model for weight allocation of an asset group, referring to a mixed monitoring mechanism of index-dominance/time-dominance for asset reallocation, reducing unsystematic risks but grasping a chance for high rewards, and supporting investment with optimized asset allocation.

### BRIEF DESCRIPTION OF THE DRAWINGS

FIG. 1 is a flow chart of a three-stage recursive method for asset allocation;

FIG. 2 is an asset price chart based on the three-stage recursive method in Embodiment 1;

FIG. 3 is an asset price chart based on the three-stage recursive method in Embodiment 2;

FIG. 4 is an asset price chart based on the three-stage recursive method in Embodiment 3;

FIG. 5 is an asset price chart based on the three-stage recursive method in Embodiment 4;

FIG. 6 is an asset price chart based on the three-stage recursive method in Embodiment 5;

FIG. 7 is an asset price chart based on the three-stage recursive method in Embodiment 6;

FIG. 8 is an asset price chart based on the three-stage recursive method in Embodiment 7;

FIG. 9 is an asset price chart based on the three-stage recursive method in Embodiment 8;

FIG. 10 is an asset price chart based on the three-stage recursive method in Embodiment 9;

FIG. 11 is an asset price chart based on the three-stage recursive method in Embodiment 10.

### DETAILED DESCRIPTION OF THE INVENTION

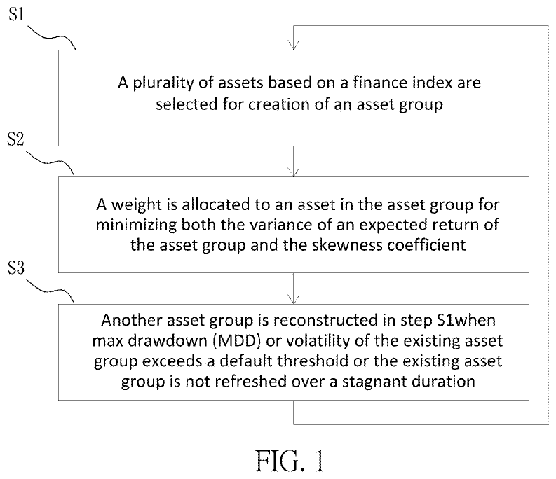

Referring to FIG. 1, which is a flow chart of a method for asset allocation in the present disclosure comprising steps as follows:
S1: A plurality of assets based on a finance index are selected from an asset trading market for creation of an asset group;
S2: A weight is allocated to an asset in the asset group for minimizing both the variance of an expected return of the asset group and the skewness coefficient;
S3: A stability index of the asset group is monitored constantly but another asset group is reconstructed in step S1 and a weight is reallocated to an asset in step S2 when max drawdown (MDD) or volatility of the existing asset group exceeds a default threshold or the existing asset group is not refreshed over a stagnant duration.

In step S1, a plurality of assets with maximum or minimum finance indexes are focused and a plurality of potential candidates are selected from the plenty of assets in the present disclosure wherein a finance index can be the Alpha or Beta coefficient of the Capital Asset Pricing Model (CAPM) or an index of behavior finance, that is, the skewness coefficient.

Furthermore, the Alpha coefficient and the Beta coefficient mean the abnormal return and the system risk parameter of an asset, respectively. With the market risk premium, [E(R_{M})−R_{ƒ}], as an independent variable and the risk premium of the ith asset, [E(Rᵢ)−R_{ƒ}], as an dependent variable in practice, the formula for relevance of the expected return of the ith asset E(Rᵢ) and the expected return of a market E(R_{M}) is derived through regression analysis by an investor:

E(Rᵢ)−R₇₁=αᵢ+βᵢ[E(R_{M})−R_{ƒ}]+εᵢ

where R_{f}, βᵢ and αᵢ are risk-free interest rate, the Beta coefficient of the ith asset and the Alpha coefficient of the ith asset, respectively.

Furthermore, the formula of the skewness coefficient for the return of the ith asset through the third moment based on adjusted historical closing prices of the ith asset is shown as follows:

$${skew}_{i} = E [ {( \frac{{R}_{i} - {μ}_{i}}{{σ}_{i}} )}^{3} ] = \frac{E [ {R}_{i}^{3} ] - 3 {μ}_{i} {σ}_{i}^{2} - {μ}_{i}^{3}}{{σ}_{i}^{3}}$$

where Rᵢ, μᵢ and σᵢ are the return of the ith asset, the expected return of the ith asset and the standard deviation of the expected return of the ith asset, respectively.

In step S2, the variance for the return of an asset group in the present disclosure is considered as the value at risk of the asset group. Moreover, with μ=(μ₁, μ₂, . . . , μ_{N}) as the expected return, W=(W₁, W₂, . . . , W_{N}) as the optimal weight and V as the covariance matrix for the asset group consisting of N assets, V_{P}=W^{T}VW=σ_{P}² is defined where 94 _{P}^{P} and V_{P} mean volatility (standard deviation) and the covariance matrix of a portfolio P, respectively.

As mentioned previously, σ_{P}²=W^{T}VW, that is, the formula for Markowitz's mean-variance optimization model, is minimized according formulas as follows:

$$Min {σ}_{P}^{2} = {W}^{T} VW \\ S . T . {W}^{T} μ = {\sum }_{i = 1}^{N} {W}_{i} {μ}_{i} = \overline{R} \\ {\sum }_{i = 1}^{N} {W}_{i} = 1 \\ {LB}_{i} \leq {W}_{i} \leq U {B}_{i} , i = 1 , 2 , … , N$$

where σ_{P}, N, R̅, Wᵢ, LBᵢ and UBᵢ mean volatility (standard deviation) of a portfolio P, the number of selected stocks, the expected return of a portfolio, the optimal weight of the ith asset, the lower limit of the optimal weight of the ith asset and the upper limit of the optimal weight of the ith asset, respectively.

In addition to the value at risk minimized, an optimal weight should be selected in the present disclosure with influence of market news on investor psychology taken into account. Accordingly, the formula for Markowitz's mean-variance optimization model is adjusted for creation of a new MVS (Mean Variance Skew) optimized asset allocation model, as shown in following formulas:

$$Min {σ}_{P}^{2} + S k e {w}_{P} \\ {Skew}_{P} = {E ( {W}^{T} ( R - μ ) )}^{3} = {\sum }_{i , j , k = 1}^{N} {W}_{i} {W}_{j} {W}_{k} E [ ( {R}_{i} - {μ}_{i} ) ( {R}_{j} - {μ}_{j} ) ( {R}_{k} - {μ}_{k} ) ]$$

where Skew_{P} is the skewness coefficient of a portfolio P.

In step S3, two automatic rebalance mechanisms, that is, static rebalance and dynamic rebalance, and new mixed rebalance by mixing static rebalance and dynamic rebalance are introduced for a volatile asset market in the present disclosure.

In the present disclosure, static rebalance means a rebalance mechanism is enabled to select another new asset group by the computer system in step S1 and an optimal weight is allocated to the asset group in step S2 when an existing asset group is not refreshed over a stagnant duration.

In the present disclosure, the profitability of assets allocated in an asset group and refreshed every month, quarter or half a year will be raised according to the patent applicant's practical experience. Based on long-term practical experience that an asset group refreshed every half a year is the optimal portfolio, a stagnant duration for static rebalance is set to half a year hereinafter.

In the present disclosure, dynamic rebalance means another asset group is reselected in step S1 when the stability index of an asset group exceeds a default threshold.

In the present disclosure, volatility (sigma) or the so-called sigma-rebalance is one stability index, which is based on the standard deviation (SD) of an expected return of the asset group as volatility to check that volatility of the latter portfolio deviates from the default threshold of volatility of the former portfolio. In the above description, the “default threshold” is defined as S% of volatility of the former portfolio. If volatility of the latter portfolio exceeds S% of the “default threshold”, a rebalance mechanism will be enabled, that is, another new asset group is reselected by the computer system in step S1 and an optimal weight is reallocated to the new asset group in step S2.

In the present disclosure, maximum intraday drawdown or so-called MDD-Rebalance is another stability index, which relies on the max drawdown (MDD) of an asset group to check that the value of the latter asset group drops and deviates from the “default threshold” of the maximum value of the adjusted former asset group. In the above definition, the “default threshold” is defined as M% of the maximum value of the former asset group. If the value of the latter asset group drops and exceeds M% of the maximum value, i.e., “default threshold”, of the adjusted former asset group, a rebalance mechanism will be enabled, that is, another new asset group is reselected by the computer system in step S1 and an optimal weight is reallocated to the new asset group in step S2.

In the present disclosure, mixed rebalance means another new asset group is reselected by the computer system in step S1 and an optimal weight is reallocated to the new asset group in step S2 when the condition to enable either dynamic rebalance or static rebalance is satisfied.

In summary, a three-stage recursive algorithm executed in the present disclosure by a computer system depends on the alpha, beta or skewness coefficient to select potential assets from a market with which an asset group is created, determine weight allocation for minimization of the standard deviation and the skewness coefficient, and reselect assets and corresponding weight allocation thereof properly through mixed rebalance for optimized asset allocation.

To verify the three-stage recursive algorithm, the patent applicant constructed a computer system with the python programming language in the present disclosure and conducted an empirical test in a program flow satisfying rigorous proof of concept for the period from Jan. 2, 2007, (Day 1 of investment) to Dec. 31, 2019: historical closing prices (which had been adjusted) for 120 consecutive trading days before Jan. 2, 2007 (Day 1 of investment) were collected to estimate required statistical and financial parameters; three risk levels, Risk1, Risk2 and Risk3, were set in the computer system; the parameters such as lower limit of weight, 2%, upper limit of weight, 50%, and investment cost, 0.5%, for each asset were set in simulations of realistic investment status for completion of the test in ten embodiments.

In Embodiment 1, the stocks with top 10 Alpha coefficients amid 50 constituent stocks selected into “Yuanta/P-shares Taiwan Top 50 ETF” are singled out in step S1, the stagnant duration set in step S3 is half a year, and the stability index for dynamic rebalance is MDD. When a deviation between MDD in the current period and MDD in the former period is more than 5%, a rebalance mechanism is enabled to resume step S1 by the computer system. In addition, the empirical test is conducted for three wealth modes, Risk1, Risk2 and Risk3, in the computer system.

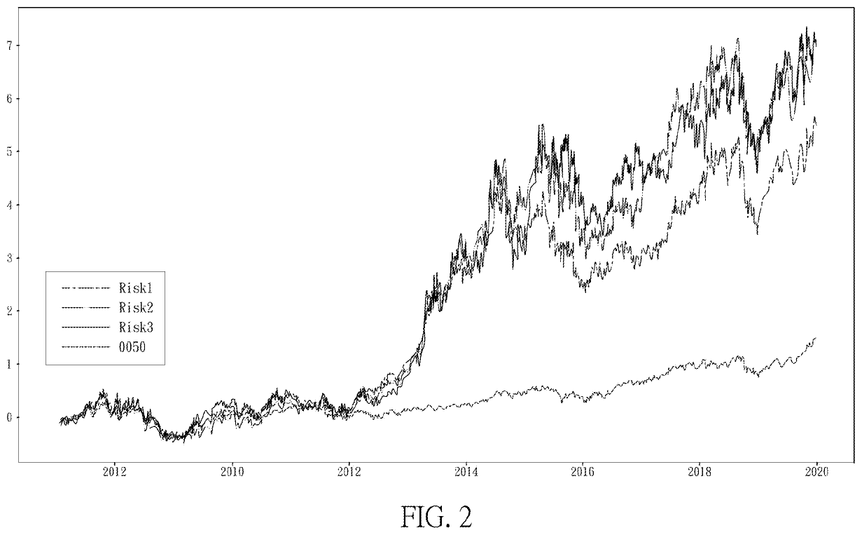

Referring to FIG. 2 and Table 1, which are the asset price chart and the performance sheet in Embodiment 1, respectively. As shown in Table 1 for execution results in the computer system, IRR in each of three risk attributes is far better than IRR of the benchmark ETF, TW0050, and Sharpe Ratio (IRR) in each of three risk attributes is also better than Sharpe Ratio (IRR) of the benchmark ETF, TW0050. In addition, the performance index of “Turn over” is defined as the number of rebalance enabled for a portfolio.

TABLE 1

| Performance index | Risk1 | Risk2 | Risk3 | TW0050 |
|---|---|---|---|---|
| IRR | 0.1571 | 0.1763 | 0.1760 | 0.0719 |
| R_sigma | 0.2959 | 0.3128 | 0.3267 | 0.1959 |
| Sharpe_IRR | 0.5311 | 0.5637 | 0.5386 | 0.3669 |
| Turn over | 136 | 145 | 172 | |

In Embodiment 2, the stocks with top 10 Alpha coefficients amid 50 constituent stocks selected into “Yuanta/P-shares Taiwan Top 50 ETF” are singled out in step S1, the stagnant duration set in step S3 is half a year, and the stability index for dynamic rebalance is volatility. When a deviation between volatility in the current period and volatility in the former period is more than 10%, a rebalance mechanism is enabled to resume step S1 by the computer system. In addition, the empirical test is conducted for three wealth modes, Risk1, Risk2 and Risk3, in the computer system.

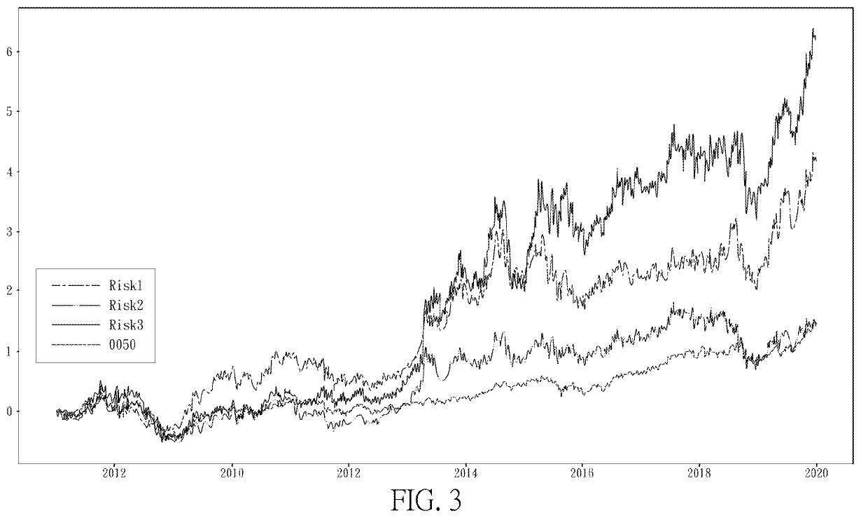

Referring to FIG. 3 and Table 2, which are the asset price chart and the performance sheet in Embodiment 2, respectively. As shown in Table 2 for execution results in the computer system, IRR in each of three risk attributes is better than IRR of the benchmark ETF, TW0050, and Sharpe Ratio (IRR) in the risk attribute of Risk1 or Risk3 is also better than Sharpe Ratio (IRR) of the benchmark ETF, TW0050.

TABLE 2

| Performance index | Risk1 | Risk2 | Risk3 | TW0050 |
|---|---|---|---|---|
| IRR | 0.1372 | 0.0725 | 0.1665 | 0.0719 |
| R_sigma | 0.2979 | 0.3093 | 0.3127 | 0.1959 |
| Sharpe_IRR | 0.4607 | 0.2344 | 0.5324 | 0.3669 |
| Turn over | 147 | 139 | 138 | |

In Embodiment 3, the stocks with top 10 Beta coefficients amid 50 constituent stocks selected into “Yuanta/P-shares Taiwan Top 50 ETF” are singled out in step S1, the stagnant duration set in step S3 is half a year, and the stability index for dynamic rebalance is MDD. When a deviation between MDD in the current period and MDD in the former period is more than 5%, a rebalance mechanism is enabled to resume step S1 by the computer system. In addition, the empirical test is conducted for three wealth modes, Risk1, Risk2 and Risk3, in the computer system.

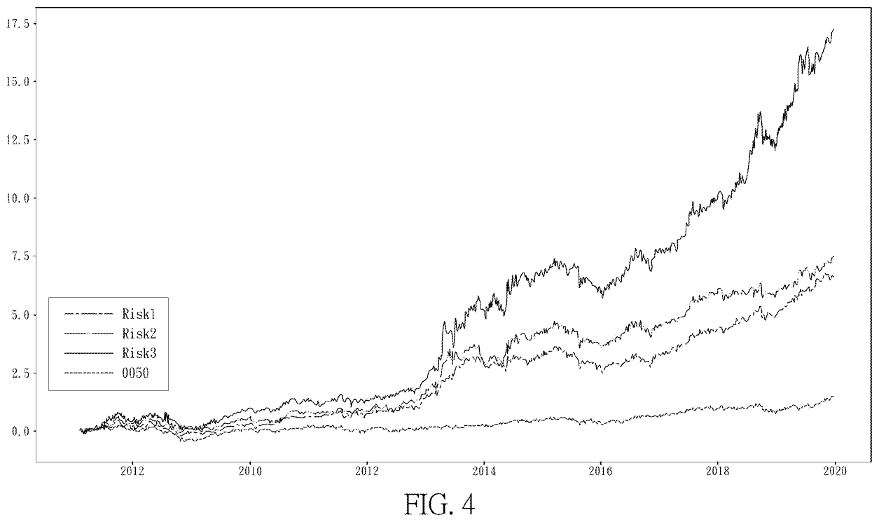

Referring to FIG. 4 and Table 3, which are the asset price chart and the perfoiiiiance sheet in Embodiment 3, respectively. As shown in Table 3 for execution results in the computer system, IRR in each of three risk attributes is far better than IRR of the benchmark ETF, TW0050, R sigma in the risk attribute of Risk1 or Risk2 is also better than R sigma of the benchmark ETF, TW0050, and Sharpe Ratio (IRR) in each of three risk attributes is better than Sharpe Ratio (IRR) of the benchmark ETF, TW0050.

TABLE 3

| Performance index | Risk1 | Risk2 | Risk3 | TW0050 |
|---|---|---|---|---|
| IRR | 0.1714 | 0.1812 | 0.2540 | 0.0719 |
| R_sigma | 0.1688 | 0.1928 | 0.2239 | 0.1959 |
| Sharpe_IRR | 1.0154 | 0.9400 | 1.1341 | 0.3669 |
| Turn over | 64 | 72 | 83 | |

In Embodiment 4, the stocks with top 10 Beta coefficients amid 50 constituent stocks selected into “Yuanta/P-shares Taiwan Top 50 ETF” are singled out in step S1, the stagnant duration set in step S3 is half a year, and the stability index for dynamic rebalance is volatility. When a deviation between volatility in the current period and volatility in the former period is more than 10%, a rebalance mechanism is enabled to resume step S1 by the computer system. In addition, the empirical test is conducted for three wealth modes, Risk1, Risk2 and Risk3, in the computer system.

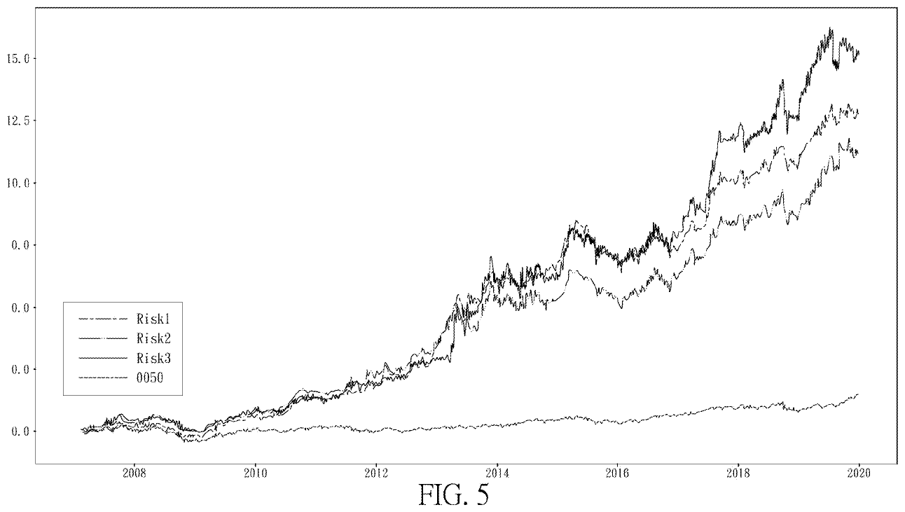

Referring to FIG. 5 and Table 4, which are the asset price chart and the performance sheet in Embodiment 4, respectively. As shown in Table 4 for execution results in the computer system, IRR in each of three risk attributes is far better than IRR of the benchmark ETF, TW0050, R sigma in the risk attribute of Risk1 is better than R sigma of the benchmark ETF, TW0050, and Sharpe Ratio (IRR) in each of three risk attributes is better than Sharpe Ratio (IRR) of the benchmark ETF, TW0050, and greater than 1.0.

TABLE 4

| Performance index | Risk1 | Risk2 | Risk3 | TW0050 |
|---|---|---|---|---|
| IRR | 0.2273 | 0.2156 | 0.2426 | 0.0719 |
| R_sigma | 0.1855 | 0.2000 | 0.2168 | 0.1959 |
| Sharpe_IRR | 1.2254 | 1.0778 | 1.1189 | 0.3669 |
| Turn over | 146 | 129 | 128 | |

In Embodiment 5, the stocks with top 10 skewness coefficients amid 50 constituent stocks selected into “Yuanta/P-shares Taiwan Top 50 ETF” are singled out in step S1, the stagnant duration set in step S3 is half a year, and the stability index for dynamic rebalance is MDD. When a deviation between MDD in the current period and MDD in the former period is more than 5%, a rebalance mechanism is enabled to resume step S1 by the computer system. In addition, the empirical test is conducted for three wealth modes, Risk 1, Risk2 and Risk3, in the computer system.

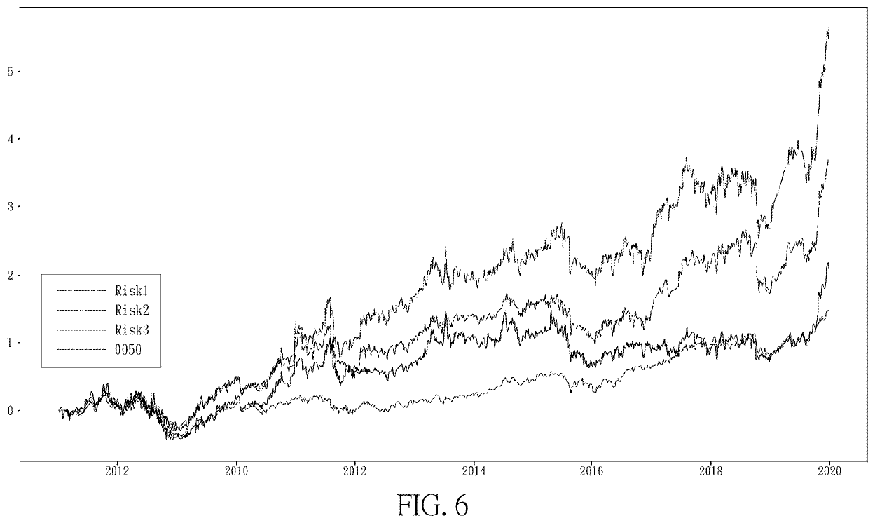

Referring to FIG. 6 and Table 5, which are the asset price chart and the performance sheet in Embodiment 5, respectively. As shown in Table 5 for execution results in the computer system, IRR in each of three risk attributes is better than IRR of the benchmark ETF, TW0050, and Sharpe Ratio (IRR) in the risk attribute of Risk1 or Risk2 is better than Sharpe Ratio (IRR) of the benchmark ETF, TM/0050.

TABLE 5

| Performance index | Risk1 | Risk2 | Risk3 | TW0050 |
|---|---|---|---|---|
| IRR | 0.1266 | 0.1573 | 0.0922 | 0.0719 |
| R_sigma | 0.2265 | 0.2463 | 0.2659 | 0.1959 |
| Sharpe_IRR | 0.5587 | 0.6387 | 0.3469 | 0.3669 |
| Turn over | 93 | 101 | 118 | |

In Embodiment 6, the stocks with top 10 skewness coefficients amid 50 constituent stocks selected into “Yuanta/P-shares Taiwan Top 50 ETF” are singled out in step S1, the stagnant duration set in step S3 is half a year, and the stability index for dynamic rebalance is volatility. When a deviation between volatility in the current period and volatility in the former period is more than 10%, a rebalance mechanism is enabled to resume step S1 by the computer system. In addition, the empirical test is conducted for three wealth modes, Risk1, Risk2 and Risk3, in the computer system.

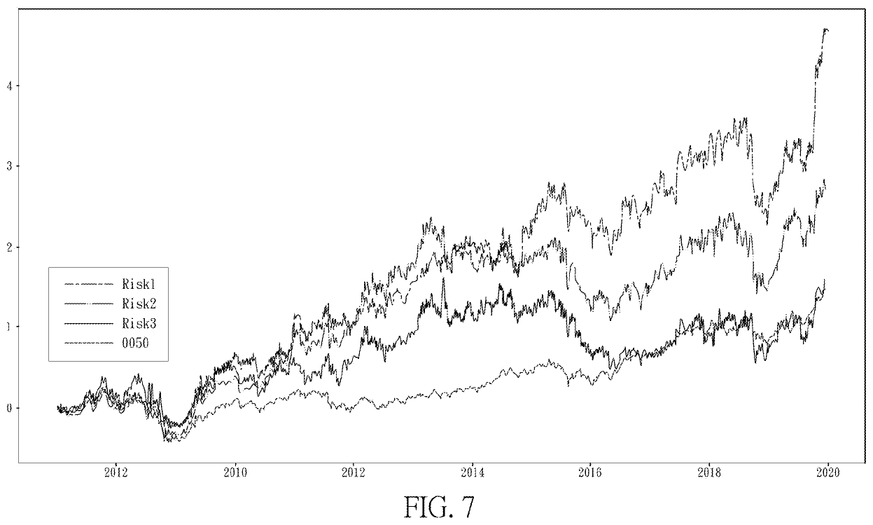

Referring to FIG. 7 and Table 6, which are the asset price chart and the performance sheet in Embodiment 6, respectively. As shown in Table 6 for execution results in the computer system, IRR in each of three risk attributes is better than IRR of the benchmark ETF, TW0050, and Sharpe Ratio (IRR) in the risk attribute of Risk1 or Risk2 is better than Sharpe Ratio (IRR) of the benchmark ETF, TW0050.

TABLE 6

| Performance index | Risk1 | Risk2 | Risk3 | TW0050 |
|---|---|---|---|---|
| IRR | 0.1444 | 0.1082 | 0.0738 | 0.0719 |
| R_sigma | 0.2443 | 0.2450 | 0.2794 | 0.1959 |
| Sharpe_IRR | 0.5909 | 0.4415 | 0.2642 | 0.3669 |
| Turn over | 136 | 143 | 137 | |

In Embodiment 7, the stocks with bottom 10 Beta coefficients amid 50 constituent stocks selected into “YuantaiP-shares Taiwan Top 50 ETF” are singled out in step S1, the stagnant duration set in step S3 is half a year, and the stability index for dynamic rebalance is MDD. When a deviation between MDD in the current period and MDD in the former period is more than 5%, a rebalance mechanism is enabled to resume step S1 by the computer system. In addition, the empirical test is conducted for three wealth modes, Risk1, Risk2 and Risk3, in the computer system.

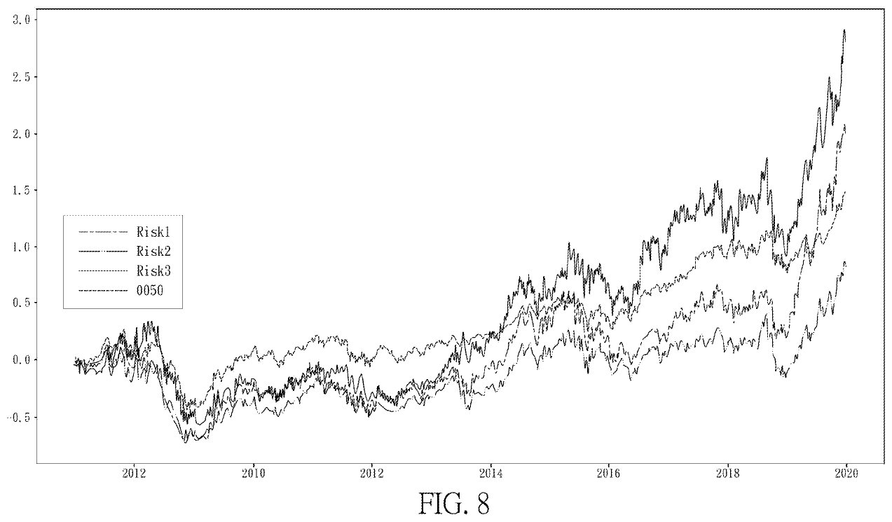

Referring to FIG. 8 and Table 7, which are the asset price chart and the performance sheet in Embodiment 7, respectively. As shown in Table 7 for execution results in the computer system, IRR in the risk attribute of Risk1 or Risk3 is better than IRR of the benchmark ETF, TW0050.

TABLE 7

| Performance index | Risk1 | Risk2 | Risk3 | TW0050 |
|---|---|---|---|---|
| IRR | 0.0890 | 0.0475 | 0.1099 | 0.0719 |
| R_sigma | 0.3181 | 0.3227 | 0.3347 | 0.1959 |
| Sharpe_IRR | 0.2797 | 0.1473 | 0.3284 | 0.3669 |
| Turn over | 164 | 171 | 175 | |

In Embodiment 8, the stocks with bottom 10 Beta coefficients amid 50 constituent stocks selected into “Yuanta/P-shares Taiwan Top 50 ETF” are singled out in step S1, the stagnant duration set in step S3 is half a year, and the stability index for dynamic rebalance is volatility. When a deviation between volatility in the current period and volatility in the former period is more than 10%, a rebalance mechanism is enabled to resume step S1 by the computer system. In addition, the empirical test is conducted for three wealth modes, Risk1, Risk2 and Risk3, in the computer system.

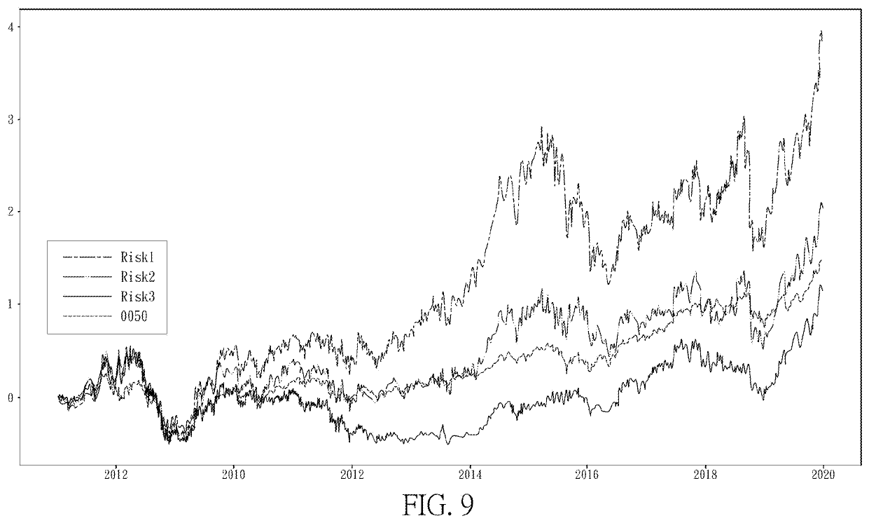

Referring to FIG. 9 and Table 8, which are the asset price chart and the performance sheet in Embodiment 8, respectively. As shown in Table 8 for execution results in the computer system, IRR in the risk attribute of Risk1 or Risk2 is better than IRR of the benchmark ETF, TW0050.

TABLE 8

| Performance index | Risk1 | Risk2 | Risk3 | TW0050 |
|---|---|---|---|---|
| IRR | 0.1316 | 0.0908 | 0.0613 | 0.0719 |
| R_sigma | 0.3060 | 0.3251 | 0.3371 | 0.1959 |
| Sharpe_IRR | 0.4299 | 0.2792 | 0.1819 | 0.3669 |
| Turn over | 144 | 151 | 152 | |

In Embodiment 9, the stocks with bottom 10 skewness coefficients amid 50 constituent stocks selected into “Yuanta/P-shares Taiwan Top 50 ETF” are singled out in step S1, the stagnant duration set in step S3 is half a year, and the stability index for dynamic rebalance is MDD. When a deviation between MDD in the current period and MDD in the former period is more than 0.05%, a rebalance mechanism is enabled to resume step S1 by the computer system. In addition, the empirical test is conducted for three wealth modes, Risk 1, Risk2 and Risk3, in the computer system.

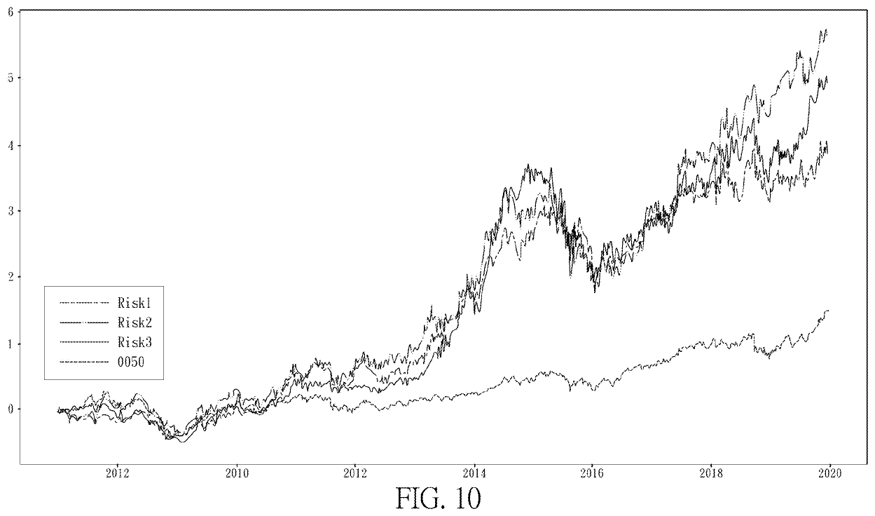

Referring to FIG. 10 and Table 9, which are the asset price chart and the performance sheet in Embodiment 9, respectively. As shown in Table 9 for execution results in the computer system, either IRR or Sharpe Ratio (IRR) in each of three risk attributes is better than IRR or Sharpe Ratio (IRR) of the benchmark ETF, TW0050.

TABLE 9

| Performance index | Risk1 | Risk2 | Risk3 | TW0050 |
|---|---|---|---|---|
| IRR | 0.1316 | 0.1593 | 0.1489 | 0.0719 |
| R_sigma | 0.2196 | 0.2324 | 0.2360 | 0.1959 |
| Sharpe_IRR | 0.5994 | 0.6857 | 0.6309 | 0.3669 |
| Turn over | 100 | 104 | 103 | |

In Embodiment 10, the stocks with bottom 10 skewness coefficients amid 50 constituent stocks selected into “Yuanta/P-shares Taiwan Top 50 ETF” are singled out in step S1, the stagnant duration set in step S3 is half a year, and the stability index for dynamic rebalance is volatility. When a deviation between volatility in the current period and volatility in the former period is more than 10%, a rebalance mechanism is enabled to resume step S1 by the computer system. In addition, the empirical test is conducted for three wealth modes, Risk1, Risk2 and Risk3, in the computer system.

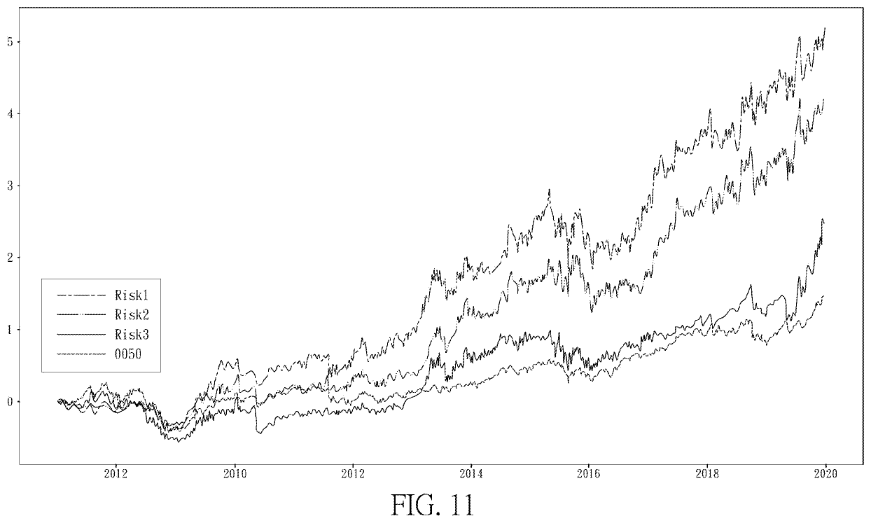

Referring to FIG. 11 and Table 10, which are the asset price chart and the performance sheet in Embodiment 10, respectively. As shown in Table 10 for execution results in the computer system, either IRR or Sharpe Ratio (IRR) in each of three risk attributes is better than IRR or Sharpe Ratio of the benchmark ETF, TW0050, and particularly either IRR or Sharpe Ratio (IRR) in the risk attribute of Risk1 is better than either IRR or Sharpe Ratio (IRR) in the risk attribute of Risk2 or Risk3.

TABLE 10

| Performance index | Risk1 | Risk2 | Risk3 | TW0050 |
|---|---|---|---|---|
| IRR | 0.1516 | 0.1367 | 0.1020 | 0.0719 |
| R_sigma | 0.2183 | 0.2265 | 0.2641 | 0.1959 |
| Sharpe_IRR | 0.6944 | 0.6038 | 0.3861 | 0.3669 |
| Turn over | 124 | 128 | 131 | |

The three-stage recursive method using a computer system for asset allocation in the present disclosure was actually tested with NTD 50 million dollar invested in the Taiwan stock market from Oct. 1, 2020, to Mar. 30, 2021, during which investment performance is profitability of 40.60% (annualized returns of 98.66%) that outweighs the percentage gain of TWSE Capitalization Weighted Stock Index (32.27%) or the benchmark ETF, 0050.TW, (34.82%).

In summary, the present invention in which the behavior finance theory and the optimization algorithm are integrated features a three-stage recursive method constructed with the “behavior finance robo-advisor model” that proves effective in providing commodities of financial investment and an allocation model continuously and automatically based on an investor's risk attribute as well as better investment performance than the benchmark ETF.

1. A three-stage recursive method, comprising steps as follows:
S1: selecting a first plurality of assets based on a finance index by a computer system for creation of an asset group;
S2: allocating a weight to an asset in the asset group by the computer system for minimizing both the variance of an expected return of the asset group and a skewness coefficient; and
S3: resuming step S1 by the computer system to reselect a second plurality of assets and allocating the weight when a stability index of the asset group exceeds a default threshold or the existing asset group is not refreshed over a stagnant duration;
wherein the finance index is the skewness, Alpha or Beta coefficient;
wherein the stability index is maximum intraday drawdown or volatility.

2. The three-stage recursive method as claimed in claim 1 wherein step S1 is executed for selection of an asset with the maximum finance index first.

3. The three-stage recursive method as claimed in claim 1 wherein step S1 is executed for selection of an asset with the minimum finance index first.

4. The three-stage recursive method as claimed in claim 1 wherein the default threshold in step S3 is the stability index of the asset group in the former period.

5. The three-stage recursive method as claimed in claim 1 wherein the maximum intraday drawdown is measured with Max Drawdown (MDD) of the asset group.

6. The three-stage recursive method as claimed in claim 1 wherein the volatility is measured with the Standard Deviation (SD) of an expected return of the asset group.

7. The three-stage recursive method as claimed in claim 1 wherein the stagnant duration is half a year.

8. The three-stage recursive method as claimed in claim 1 wherein step S1 is executed for selection of an asset with the maximum Beta coefficient, the stability index is maximum intraday drawdown and the stagnant duration is half a year.

9. The three-stage recursive method as claimed in claim 1 wherein step S1 is executed for selection of an asset with the minimum skewness coefficient, the stability index is maximum intraday drawdown and the stagnant duration is half a year.
